(19) United States
(12) Patent Application Publication
(10) Pub. No.: US 2007/0256289 A1
(43) Pub. Date: Nov. 8, 2007

(54) Method of manufacturing injection needle and injection needle

(76) Inventors: Satoru Tamura, Tokyo (JP); Akira Kenjyo, Tokyo (JP)

Correspondence Address: MALLOY & MALLOY, P. A., 2800 S. W. Third Avenue Historic Coral Way, Miami, FL, 33129, US

(21) Appl. No.: 11/728,208

(22) Filed: Mar. 23, 2007

(30) Foreign Application Priority Data
Mar. 31, 2006 (JP) 2006-097508
Mar. 1, 2007 (JP) 2007-052082

(51) Int. Cl. B23P 17/00

(52) U.S. Cl. 29/527.1

(57) ABSTRACT

An injection needle master is manufactured (S1), the injection needle master is mounted on a master receiving holder (S2), an electroforming metal is adhered to the injection needle master by an electroforming treatment (S3) and, finally, the injection needle master is pulled from an electroforming tank together with the master receiving holder whereupon the electroforming body, which constitutes the injection needle main body, is released from the injection needle master (S4). The manufactured injection needle comprises a tapered portion in which the outer diameter of the puncture tip-end portion is about 0.12 mm and in which the outer diameter narrows between the base-end portion and the puncture tip-end portion.

### CLAIM OF PRIORITY

This application claims the priorities of Japanese Patent Application No. 2006-097508 filed on Mar. 31, 2006 and Japanese Patent Application No. 2007-052082 filed on Mar. 1, 2007, which are incorporated herein by reference.

### BACKGROUND OF THE INVENTION

1. Field of the Invention

The present invention relates to a method of manufacturing an injection needle used when a liquid such as a medicine is injected into a living body or the like, and to an injection needle manufactured by the method, and more particularly to a method of manufacturing a very narrow injection needle with a needle tip diameter of about, for example, not more than 0.13 mm, and this injection needle.

2. Description of the Related Art

The thickness of a conventional injection needle is comparatively large with an outer diameter about between 0.3 mm and 2.0 mm. The outer diameter of injection needles used for self-injection of insulin and dental anesthesia are also about 0.2 mm or more.

The pain of an injection is known to be related to the thickness of the injection needle and, accordingly, the thinner the needle the less the pain. For self-administered injections in particular, narrowing the outer diameter of the needle can help alleviate the anxiety and feelings of fear experienced by a patient.

However, narrowing the thickness of an injection needle creates a strength problem and, because of the unavoidable narrowing of the inner diameter thereof as a result and, in turn, the marked increase in flow resistance when a medicine is injected into a living body that this causes, narrow injection needles must of necessity be of a strength sufficient to push the medicine out during the injection.

With these conditions in mind, an injection needle that describes a tapered shape from a base-end portion to a tip-end portion in which the tip-end portion for puncturing the living body is narrowly formed and the base-end portion that connects with a syringe main body is thickly formed has been disclosed (see Japanese Unexamined Patent Publication No. 2004-41391).

The injection needle described in Japanese Unexamined Patent Publication No. 2004-41391 is formed by curling a cast stainless steel material flat plate into a cylindrical-shape with the outer diameter narrowing towards the tip. Another known injection needle is formed by curling a stainless steel material flat plate into a cylindrical shape and bonding the tip-end portions thereof, and then planning the cylindrical stainless steel so that the outer diameter narrows toward the tip (manufactured by Novo Nordisk Pharmaceuticals, Ltd.).

However, because a stainless steel material flat plate is curled into a cylindrical shape in each of the technologies of the prior art described above, the curled and abutted edge surfaces thereof must be bonded by a means such as welding or the like which, at the bonded portion thereof, produces a seam created that creates an unavoidable obstruction to smooth liquid flow. In addition, the increased number of complicated steps created by the need to implement a step for curling and a step for bonding a stainless steel material flat plate increases both the manufacturing time and the manufacturing costs.

While a means based on draw machining of a metal pipe of thick diameter to narrow the diameter thereof constitutes a known technology for manufacturing a metal pipe of stainless steel or the like of narrow diameter, administering of this draw machining on a metal pipe creates fine wrinkles and creases on the inner wall surface which, in the absence of administering a polishing processing on the inner wall surface thereof, serve as an obstruction to smooth liquid flow. Accordingly, employment of means such as this for manufacturing an injection needle is, in reality, difficult. In addition, administering of this draw machining necessitates the use of a machine oil at the manufacturing stage, and the need to perform an adequate degreasing treatment inherent to the application of this means for manufacturing an injection needle adds further to the complexity of the manufacturing steps thereof.

### SUMMARY OF THE INVENTION

With the foregoing conditions in mind, it is an object of the present invention to provide a method of manufacturing an injection needle in which, in the manufacture of a cylindrical-shaped injection needle of narrow diameter, smooth liquid flow is ensured without need to carry out a bonding processing or a polishing processing on the inner wall surface and, in addition, in which the manufacturing steps thereof can be simplified, and an injection needle.

The method of manufacturing an injection needle of the present invention constitutes a method of manufacturing an injection needle comprising a hollow cylindrical body extending from a base-end portion to a puncture tip-end portion, the method comprising the steps of: arranging an electroforming metal in an electroforming tank and filling the electroforming tank with an electroforming liquid; immersing an injection needle master in the electroforming liquid; carrying out an electroforming treatment to adhere the electroforming metal to an outer surface of the injection needle master; and releasing the adhered metal from the injection needle master to obtain an injection needle main body.

Furthermore, the injection needle of the present invention constitutes an injection needle manufactured by the method of manufacturing an injection needle as described above, wherein the outer diameter of the puncture tip-end portion is not more than 0.25 mm, a cross section perpendicular to the axial line of the cylindrical body describes a ring shape from the base-end portion to the tip-end surface of the puncture tip-end portion to form the injection needle having a tip end shape.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a flow chart of the steps for manufacturing an injection needle pertaining to one embodiment of the present invention;

FIGS. 2A to 2F are cross-sectional views of examples of the shape of an injection needle master;

FIG. 3 is a schematic view of a state in which the injection needle master is mounted on a master holder;

FIGS. 4A to 4D are schematic views of a state in which an electroforming metal is adhered to the injection needle master by means of an electroforming treatment;

FIGS. 5A and 5B are schematic views of a state in which the injection needle main body is released from the injection needle master;

FIGS. 6A to 6F are cross-sectional views of examples of the shape of a manufactured injection needle;

FIGS. 6G to 6H are perspective views in partial cutaway of examples of the shape of a manufactured needle.

FIG. 7 is a schematic view of a state in which the injection needle pertaining to this embodiment is affixed to a needle base-end portion;

FIG. 8A is a cross-sectional view of a modification of the shape of the injection needle master, FIG. 8B is a cross-sectional view of a state in which the electroforming metal is adhered to a circumference of the injection needle master, and FIG. 8C is a schematic view of an electroforming apparatus used for this process; and

FIG. 9 is a cross-sectional view of a modification of the shape of the manufactured injection needle.

Like reference numerals refer to like parts throughout the several views of the drawings.

### DETAILED DESCRIPTION OF THE PREFERRED EMBODIMENT

An embodiment of the present invention will be described in detail hereinafter with reference to the drawings.

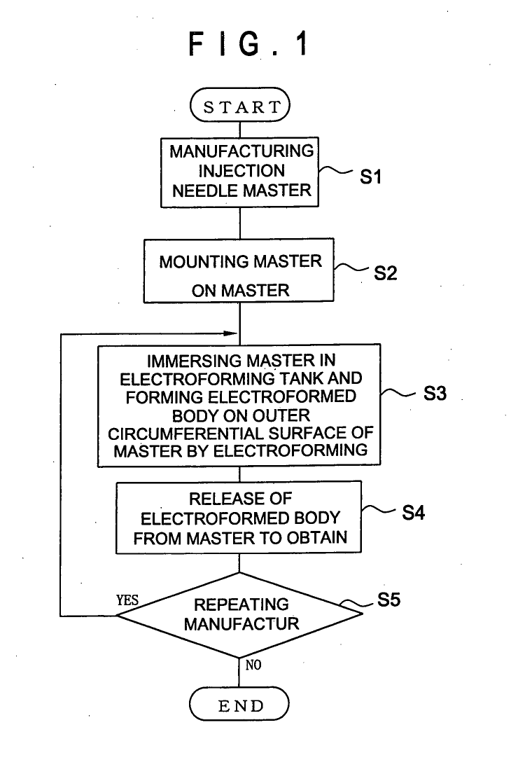

FIG. 1 is a flow chart of steps for manufacturing an injection needle pertaining to one embodiment of the present invention.

First, an injection needle master is manufactured (S1).

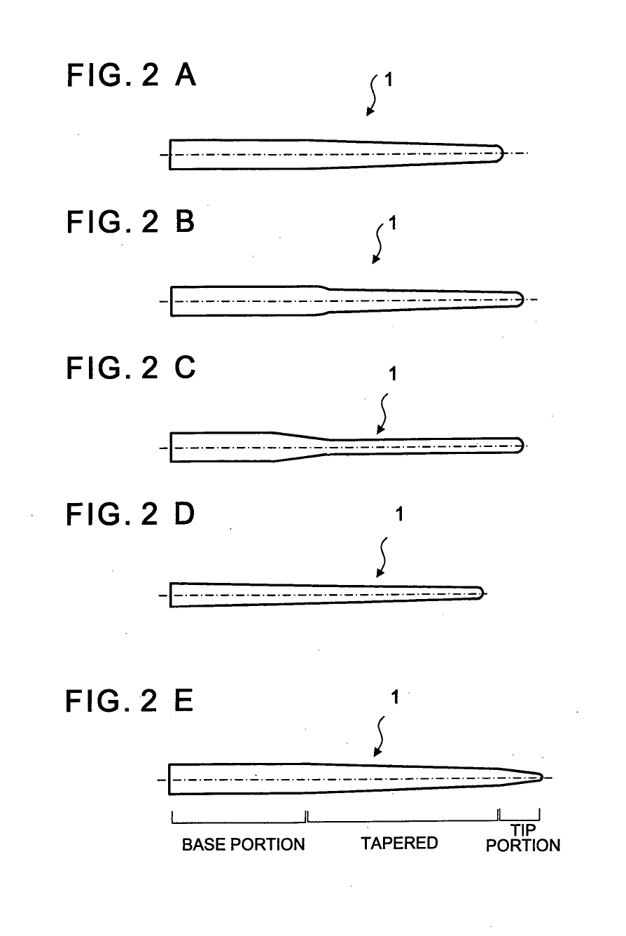

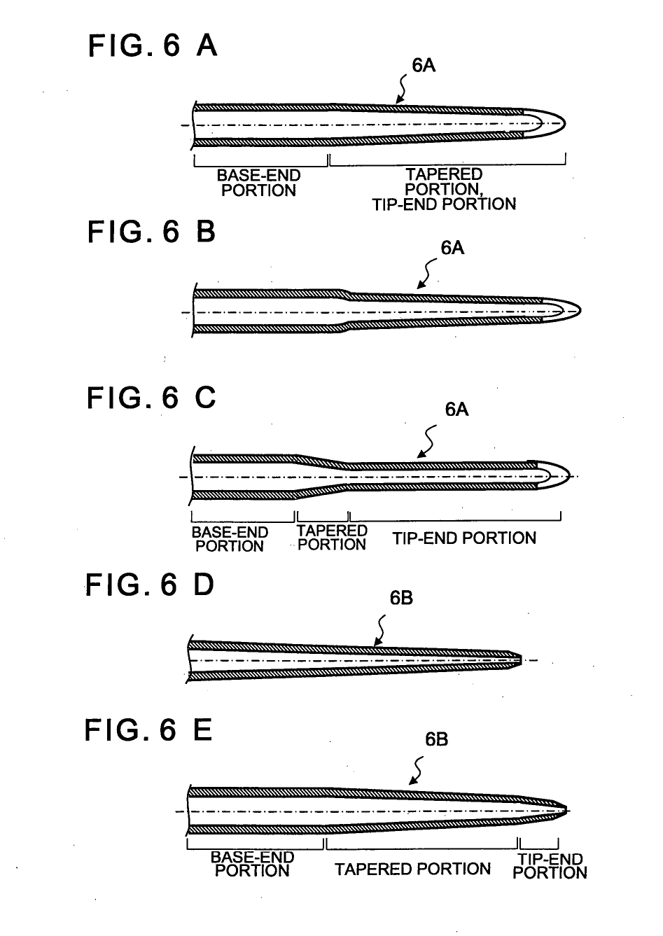

This step for manufacturing the injection needle master involves manufacture of an injection needle master that functions as an injection needle internal cast mold. An electroconductive material such as stainless steel (SUS) or a non-electroconductive material (plastic or nylon or the like on which an electroconductive treatment has been administered) is employed to manufacture the master, the outer surface of which is subjected to a polishing processing to produce a mirror-surface. While FIGS. 2A to 2F show an example of the shape of an injection needle master 1 having a tapered portion in at least one portion of the external form range, the shape thereof is not restricted thereto and, as will be described later, a rod-shaped injection needle having no tapered portion may also be manufactured. While the injection needle master 1 shown in FIGS. 2A to 2C corresponds to the injection needle shape with a blade edge shown in FIG. 6G in which the tip-end portion is cut in the diagonal, the injection needle master 1 shown in FIGS. 2D to 2F corresponds to an injection needle shape having no blade edge in the tip-end portion as shown in FIG. 6H.

Examples of the outer diameter size of this injection needle master 1 include, for example, for an injection needle with a tapered portion, a base portion diameter (thick diameter) of 0.13 mm and a tip portion diameter (narrow diameter) between 0.09 mm and 0.11 mm, and for rod-shaped injection needles described below, which do not have a tapered portion, a diameter between 0.125 mm and 0.129 mm. In addition, the length of the injection needle master 1 is, for example, a base portion length (length in the range where the diameter does not change) of 5 mm, the total length of the tapered portion and tip portion being 20 mm.

Next, the injection needle master is mounted on a master holder (S2).

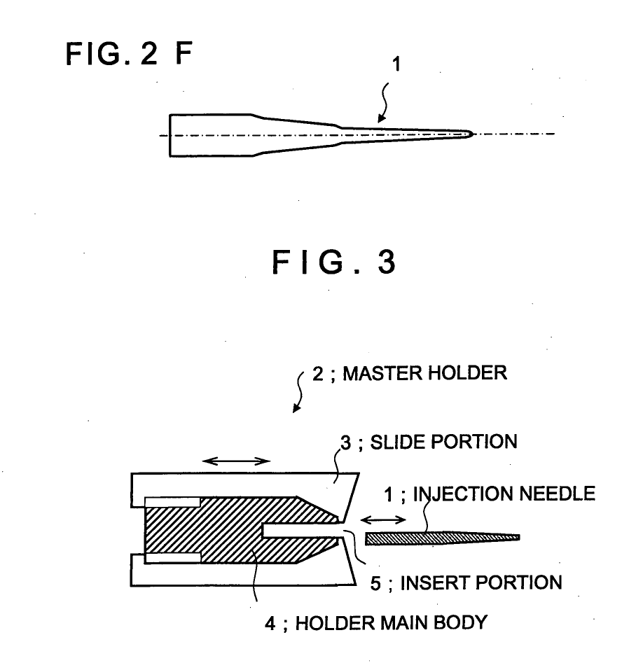

This step for mounting the injection needle master on the master holder involves the injection needle master 1 as shown in FIG. 3 being mounted on a master holder 2 connected to a cathode. The master holder 2 of, for example, the shape shown in FIG. 3, is configured from a conductive material such as brass or stainless steel. That is to say, an insert portion 5 in which the base portion of the injection needle master 1 is inserted is formed in the tip portion of the master holder 2 shown in FIG. 3 and, in addition, a slide portion 3 made of plastic material or the like that covers the outer circumferential surface of the holder main body 4 and, in accordance with need, is slidable with respect to the holder main body 4 is engaged with the outer circumferential portion of the holder main body 4.

In the step for mounting the injection needle master on the master holder, the base portion of the injection needle master 1 is inserted into the insert portion 5 of the master holder 2. In addition, for example, a predetermined inner wall portion of the insert portion 5 is formed from a magnetic material whereupon, accordingly, an injection needle master 1 made of stainless steel (SUS) is one-touch mountable. Furthermore, in addition to, or instead of this, a chuck-type mounting mechanism may be provided.

Next, an electroforming metal is adhered on the injection needle master 1 (S3).

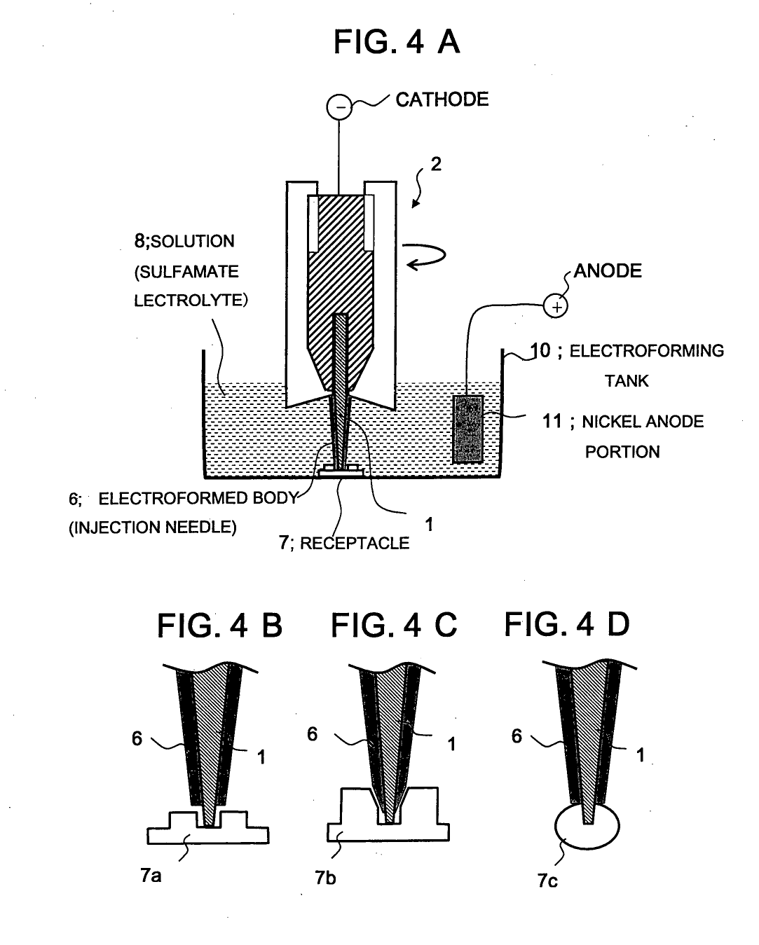

In this electroforming treatment step, as shown in FIG. 4A, an electroforming tank 10 is filled with a nickel sulfamate solution (sulfamate electrolyte) 8, and the injection needle master 1 mounted on the master holder 2 and an anode (actually configured from an Ni material and the like surrounded by a net made of Ti or the like. Hereinafter referred to as the Ni anode portion) 11 employing a Ni material serving as the electroforming metal (other materials able to be used in this solution, include Ni—Au, Ni—Ti and so on) are immersed in this solution. The master holder 2 is connected to the cathode and the Ni anode portion 11 is connected to the anode at this time. In addition, to prevent the electroforming metal adhering to the tip of the injection needle master 1, a receptacle 7 made of plastic is provided to cover the tip of the injection needle master 1.

FIGS. 4B and 4C show examples of the receptacle 7. While the receptacle 7a shown in FIG. 4B is suitable for manufacture of an injection needle (a processing for cutting the tip in the diagonal being administered thereafter) 6A that has a blade edge corresponding to FIG. 6G, the receptacle 7b shown in FIG. 4C is suitable for manufacture of an injection needle 6B that has no blade edge corresponding to FIG. 6H. The receptacle 7 is irrelevant if the injection needle master 1 is to be moved within the solution 8. In this case, as shown in FIG. 4D, it is preferable that a spherical resin member 7c configured from an insulating material be affixed to the tip of the injection needle master 1 to cover the tip prior to the electroforming treatment being carried out, and that a means be adopted to remove the resin member 7c following the electroforming treatment. Naturally, the shape of the resin member 7c is not restricted to a spherical shape.

A predetermined voltage is applied between the cathode and the anode in this state. This produces a predetermined current in the electroforming solution 8 (normally, this is constant current controlled) which results in the Ni being adhered to the circumference of the injection needle master 1 whereupon, after a predetermined time, an injection needle main body configured from an electroformed member 6 of predetermined thickness is formed. In addition, the injection needle master 1 is desirably rotated at a predetermined speed about its axis. This rotating operation ensures uniform electrodeposition.

The electroforming treatment time and applied voltage (electric current) may be established in advance in accordance with the previous data or the like, and the thickness of the electroforming metal adhered to the circumference of the injection needle master 1 may be monitored and adjusted in accordance with measured values thereof.

Next, the master holder 2 is pulled up out of the electroforming tank 10 with the injection needle master 1 in the mounted state thereon, following which the electroformed member 6 that constitutes the injection needle main body is released from the injection needle master 1 (S4).

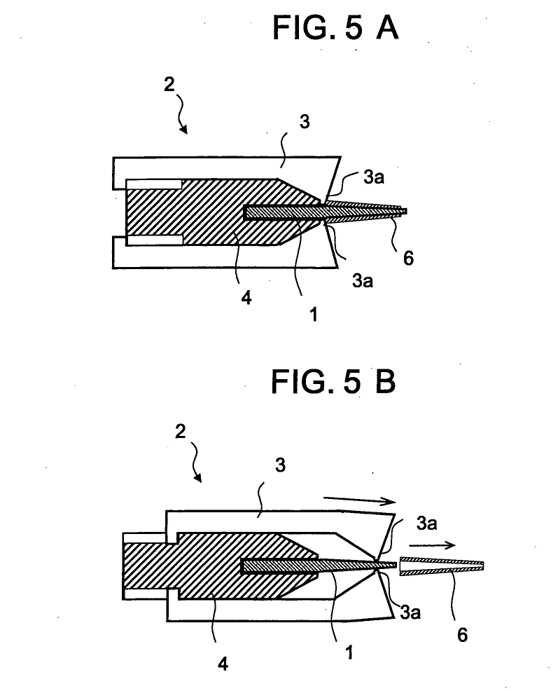

FIGS. 5A and 5B show a state in which the electroformed member 6 that constitutes the injection needle main body is released from the injection needle master 1. That is to say, with the injection needle master 1 inserted in the insert portion 5, the plastic slide portion 3 that is slidable with respect to the holder main body 4 is caused to slide in the direction of the tip portion of the injection needle master 1 (from the state of FIG. 5A to the state of FIG. 5B). The tip-end portion of the slide portion 3 has a projection part 3a that protrudes enough to abut the surface of the injection needle master 1, the elastic hook part 3a being urged along the surface direction of the injection needle master 1. Accordingly, the hook part 3a is moved along the surface of the injection needle master 1 accompanying the slide of the slide portion 3 in the tip portion direction of the injection needle master 1. As a result, the electroformed member 6 is released from the injection needle master 1 by the hook part 3a and an injection needle main body is obtained. Employing this means, release of the electroformed member 6 from the injection needle master 1 is very simple. In addition, because the electroformed member 6 can be released without damage being caused to the injection needle master 1, the injection needle master 1 can be repeatedly utilized and, in turn, manufacturing costs can be reduced.

In addition, different to the means described above, the electroformed member 6 may be released from the injection needle master 1 after the injection needle master 1 has been removed from the master holder 2.

Manufacture of the required number of injection needles requires a judgment of whether or not Steps S3 and S4 described above are to be repeated (S5).

FIGS. 6A to 6F are cross-sectional views of various different modes of injection needle shape obtained in this way. As is clear from these cross-sectional views, the outer wall surface and inner wall surface in each of the states of FIGS. 6A to 6F describe a tapered shape in at least one portion of at least the middle portion from the puncture tip-end surface to the base-end portion.

The injection needles shown in FIGS. 6A to 6C are obtained by cutting of the tip-end face of the injection needle main body in the diagonal in a state following the release afforded by Step 4 (S4), a blade edge being formed in the tip-end portion thereof as a result.

While the outer diameter size of the injection needle 6A in this case is, for example, outer diameter 0.23 mm and inner diameter 0.20 mm in the base-end portion (thick diameter) and outer diameter 0.12 mm and inner diameter 0.10 mm in the tip-end portion (narrow diameter), various inner and outer diameters can be manufactured by the shape of injection needle master 1.

As shown in FIGS. 6D to 6F, the puncture tip-end portion of the injection needle need not be cut in the diagonal and may describe a ring-shaped cross section perpendicular to the axial line of the cylinder to the tip-end surface of the puncture tip-end portion.

In addition, the cross-section including this axial line may describe a so-called multi-stepped tapered shape in which the taper angle with respect to the axial line in the region of the surface of the tip-end portion is formed larger than the taper angle with respect to the axial line of the surface of a region of the base-end portion (tapered portion) side (see FIG. 6E).

The outer diameter size of the injection needle 6B in this case is, for example, outer diameter 0.23 mm and inner diameter 0.20 mm in the base-end portion (thick diameter) and outer diameter 0.10 mm and inner diameter 0.08 mm in the tip-end portion (narrow diameter).

Damage to the tissue of a living body can be minimized by forming the puncture tip-end portion with no blade edge shape in this way. By adopting an outer diameter of puncture tip-end portion of no more than 0.25 mm and preferably no more than 0.10 mm, the injection resistance is reduced and smooth liquid flow occurs smoothly even without the puncture tip-end portion being formed with a blade edge shape.

In addition, FIG. 6G is a schematic perspective view of the injection needle 6A with blade edge shown in FIGS. 6A to 6C, and FIG. 6H is a schematic perspective view of the injection needle 6B with no blade edge corresponding to the injection needles shown in FIGS. 6D to 6F.

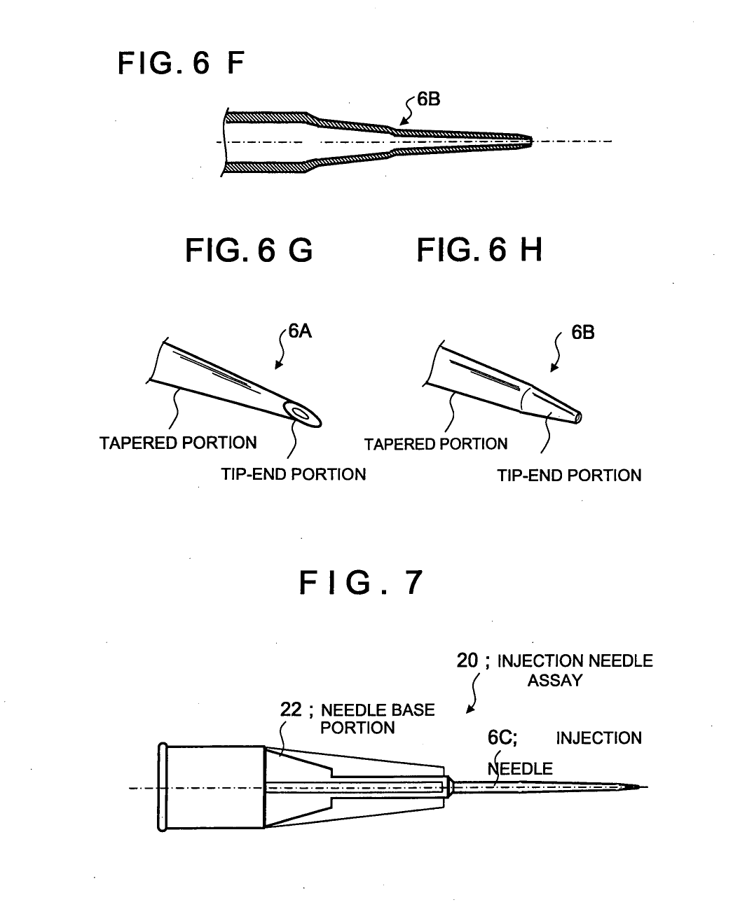

While FIG. 7 is a schematic view of a master holder 20 formed by affixing the injection needle 6C pertaining to this embodiment to a needle base-end portion 22, the mode of affixing the injection needles pertaining to the present embodiment is obviously not restricted thereto.

In addition, the method of manufacturing an injection needle and injection needle of the present invention is not restricted to this embodiment, and various other alterations may be made to the mode thereof.

For example, while the embodiment mode described above describes manufacture of a single injection needle, electroforming treatments are often simultaneously carried out on a large number of injection needle masters to afford improved manufacturing efficiency.

In addition, the shape of the electroforming tank, the type of electroforming liquid, the type of electroforming metal, and the shape and constituent materials of the injection needle master or master holder thereof may be altered as appropriate. For example, various metal materials (including alloys) other than the metal materials described above including rare earth transition metal materials and so on with a super elasticity and shape memory characteristics such as a Co—Ni alloy can be used as the electroforming metal.

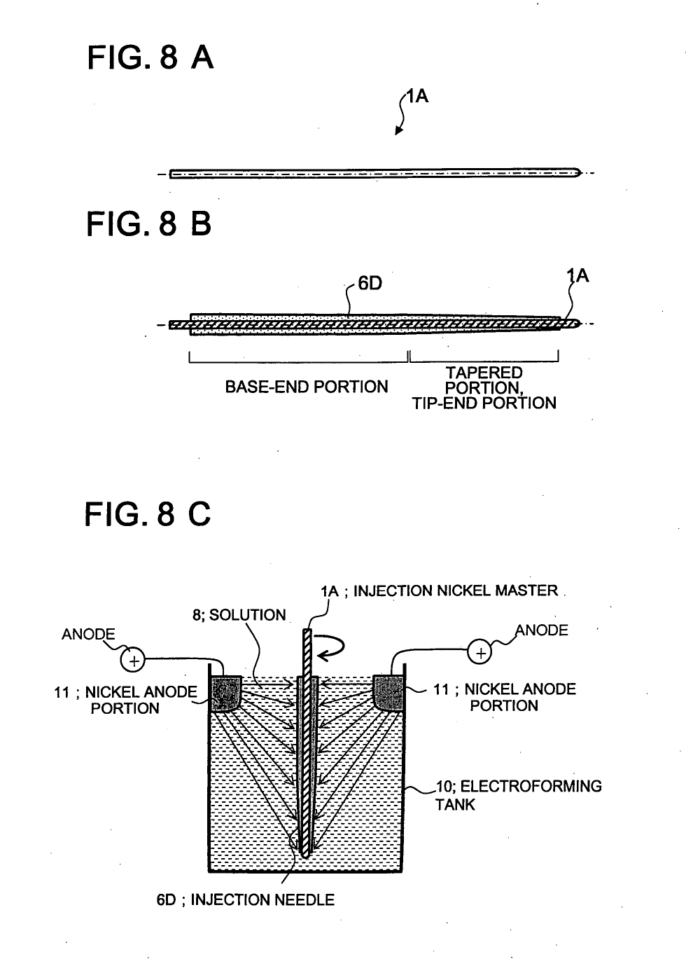

Furthermore, the external shape of the injection needle master 1 shown in FIGS. 2A to 2F changes in a tapered shape (including a multi-stepped tapered shape) from the base-end portion toward the tip-end portion, and the inner diameter of the injection needles 6A, 6B formed as a result changes in accordance with the external shape of the injection needle master 1. However, an injection needle master 1A configured from a columnar-shaped rod of uniform outer diameter as shown in FIG. 8A may be employed. FIG. 8B shows a state in which an electroforming metal is formed by electroforming treatment on the circumference of the injection needle master 1A of uniform outer diameter to form an injection needle 6D with an external tapered shape form.

In addition, FIG. 8C shows a state in which an electroforming metal (Ni) is adhered by the electroforming apparatus shown in FIG. 4 or a comparable electroforming apparatus to the outer surface of an injection needle master 1A (core), the electroforming metal being more thickly adhered to the base-end portion in close proximity to the nickel anode portion (electrode) 11 and more thinly toward the tip-end portion further away therefrom.

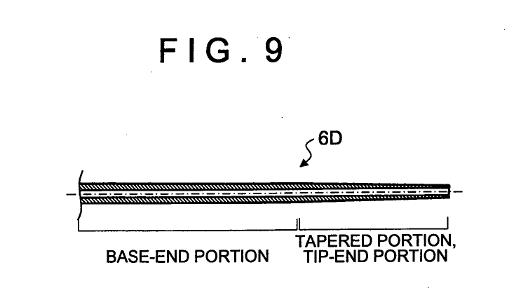

Furthermore, FIG. 9 shows a manufactured injection needle 6D obtained by drawing of the injection needle master 1A. Notably, the external shape of the injection needle 6D can be formed substantially similarly to that of the injection needles 6A, 6B shown in the diagrams of FIG. 6.

Use of an injection needle 6D of uniform inner diameter from the base-end portion to the tip-end portion such as this is advantageous in that the flow path resistance to the medicine to be injected into the living body can be reduced and, in turn, the force required to push out the medicine can be reduced.

According to the method of manufacturing an injection needle of the embodiment described above, an electroforming metal is adhered to the outer surface of an injection needle master by an electroforming treatment, and the adhered metal (electroformed body) is released from the injection needle master to obtain an injection needle main body.

Based on this means, a metal pipe of a desired shape can be manufactured on the circumference of an injection needle master and, accordingly, unlike in the prior art, the manufacture of the pipe does not necessitate carrying out of a bonding processing. As a result, the manufacturing steps can be simplified, and smooth liquid flow is ensured.

In addition, because the need to administer draw machining in the manufacture of the pipe is eliminated and, accordingly, there are no wrinkles and creases or the like formed on the pipe inner wall, the need to administer a polishing processing or the like on the inner wall surface is eliminated. In addition, because there is no oil components used, the need to carry out a degreasing treatment is eliminated. To that end, the manufacturing steps can be further simplified.

Of course, because the outer wall surface of the injection needle master is transferred to the pipe inner wall surface, a pipe inner wall surface of very good surface roughness can be produced by, for example, mirror-surface processing of the outer wall surface of the injection needle master whereupon, in turn, smooth liquid flow is ensured. In addition, because an electroforming method is employed, a satisfactory outer wall surface roughness that ensures the puncture of a living body or the like is able to be smoothly executed can be formed.

In addition, because the injection needle of the embodiment described above is produced employing an electroforming method as described above, the action and effect afforded by the method of manufacturing described above are similarly reflected in the injection needle. In addition, the vertical cross section in the axial line of the injection needle describes a ring shape to the tip-end surface of the puncture tip-end portion without the puncture tip-end portion being cut in the diagonal. That is to say, the puncture tip-end portion describes a rotationally symmetric shape with respect to the axial line that, in the puncture of a living body or the like, minimizes the damage imparted to the tissue. Because the outer diameter of the puncture tip-end portion is narrowed in diameter to no more than 0.25 mm, the pain of puncturing can be reduced and, moreover, the puncturing can be executed easily without need for the puncture tip-end portion to be cut in the diagonal.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method of manufacturing an injection needle comprising a hollow cylindrical body extending from a base-end portion to a puncture tip-end portion, the method comprising the steps of:
arranging an electroforming metal in an electroforming tank and filling the electroforming tank with an electroforming liquid;
immersing an injection needle master in the electroforming liquid;
carrying out an electroforming treatment to adhere the electroforming metal to an outer surface of the injection needle master; and
releasing the adhered metal from the injection needle master to obtain an injection needle main body.

2. The method of manufacturing an injection needle according to claim 1, wherein an external form of the injection needle master is formed to describe a tapered shape between a large diameter base portion corresponding to the base-end portion and a small diameter tip portion corresponding to the tip-end portion.

3. The method of manufacturing an injection needle according to claim 1, wherein the injection needle master is formed as a columnar-shaped rod having a substantially uniform outer diameter from a large diameter base portion corresponding to the base-end portion and a small diameter tip portion corresponding to the tip-end portion.

4. The method of manufacturing an injection needle according to claim 3, wherein the electroforming treatment is carried out so that the thickness of the adhered electroforming metal reduces from the base portion to the tip portion of the columnar-shaped rod.

5. The method of manufacturing an injection needle according to claim 1, wherein nickel or a nickel alloy is employed as the electroforming metal, and a sulfamate electrolyte is employed as the electroforming liquid.

6. The method of manufacturing an injection needle according to claim 1, wherein an electroforming metal adhering protective cover is arranged on the tip portion of the injection needle master when carrying out the electroforming treatment.

7. The method of manufacturing an injection needle according to claim 1, comprising the steps of:
holding a base portion of the injection needle master in a state of electrical connection to a metal holder;
connecting the metal holder to a cathode;.
immersing the injection needle master in the electroforming liquid; and
carrying out the electroforming treatment while the injection needle master is being rotated about an axial center thereof.

8. The method of manufacturing an injection needle according to claim 7, wherein, an electroforming metal adhering protective cover is arranged on the tip portion of the injection needle master when carrying out the electroforming treatment.

9. An injection needle manufactured by an injection needle manufacturing method for obtaining an injection needle comprising a hollow cylindrical body from a base-end portion to a puncture tip-end portion, the injection needle being manufactured by the steps of: arranging an electroforming metal in an electroforming tank and filling the electroforming tank with an electroforming liquid; immersing an injection needle master in the electroforming liquid; carrying out an electroforming treatment to adhere the electroforming metal to an outer surface of the injection needle master; and releasing the adhered metal from the injection needle master, wherein
an outer diameter of the puncture tip-end portion is not more than 0.25 mm, and
a cross section perpendicular to an axial line of the cylinder body describes a ring shape from the base-end portion to the tip-end surface of the puncture tip-end portion to form the injection needle having a tip end shape.

10. The injection needle according to claim 9, wherein an outer diameter of the puncture tip-end portion is not more than 0.13 mm.

11. The injection needle according to claim 9, wherein nickel or a nickel alloy is employed as the electroforming metal.
